(19) United States
(12) Patent Application Publication
(10) Pub. No.: US 2006/0185251 A1
(43) Pub. Date: Aug. 24, 2006

(54) Pre-fabricated sliding door

(76) Inventor: Gideon Gorjian, Great Neck, NY (US)

Correspondence Address: MEREDITH & KEYHANI, PLLC, 330 MADISON AVE., 6TH FLOOR, NEW YORK, NY, 10017, US

(21) Appl. No.: 11/064,285

(22) Filed: Feb. 23, 2005

(51) Int. Cl. E05D 15/06

(52) U.S. Cl. 49/410

(57) ABSTRACT

The present invention provides a pre-fabricated door assembly having a first panel having with at least one panel fastener along the top portion of the first panel for attaching to a stud; a second panel having at least one panel fastener along the top portion of the second panel for attaching to a stud; an upper track assembly fixedly attached to the first panel and the second panel; at least two fasteners for attaching the first panel to the second panel, such that the second panel is parallel to and at least % of an inch from the first panel; a door having a wheel assembly fixedly attached to it's top portion; wherein the upper track assembly receives the wheel assembly to provide a hanging, sliding door.

### BACKGROUND OF THE INVENTION

The present invention generally relates to sliding doors and specifically to pre-fabricated, easy to install sliding doors.

Sliding doors can be very attractive and useful for a number of reasons. Handicapped individuals may find them to alleviate many of the issues that they may incur with the simple task of opening a door. While a conventional door would require pulling the door open while at the same time moving backwards, a sliding door only requires a pushing motion to one side. Similarly, hospitals will find utility in a one handed, automated function while pushing a patient in a stretcher or equipment.

Another advantage of sliding doors is that they take up less room. Because sliding doors do not have a swinging door, there is no need to leave the area adjacent to the doorway free of furniture. This can be very useful in areas where space is a commodity. Also, sliding doors provide better insulation properties than swinging doors and excellent structural qualities, and less damage from “slamming.”

Despite the number of advantages that sliding doors provide, swinging doors remain the standard. This is because of the great difficulty and expense associated with their installation. U.S. Pat. No. 6,276,091 discloses a typical sliding door configuration. As shown, there is a substantially rectangular sliding door doorway with a door frame formed by a lower doorway frame member, an upper doorway frame member, a first vertical doorway frame member, and a second vertical doorway frame member, the sliding door doorway being between an inside area and an outside area. There is a door slidably received by the upper and lower doorway frame members. The door having a first rectangular door frame with a first vertical door frame member and a second vertical door frame member. The first vertical door frame member having a coupling passageway formed therein, the second vertical door frame member having a locking passageway formed therein, the first glass door being adapted to slide to a position wherein the first vertical door frame member is in sealed engagement with the first vertical doorway frame member. There may also be additional doors and screens. There is also a a coupling member operably received in the door frame member such that the coupling member can engage the coupling passageway when a glass door is in a particular position.

The '091 patent makes clear one of the problems with the prior art. The problem is the number of door jambs and working part that are requires to provide a sliding door. A door jamb consists of at least a top and two sides, and usually many more sides and parts. Each of these sides and parts adds complexity to the project and generally requires the time of a handyman or contractor, which can be expensive. It is a purpose of the present invention to provide a very easy to use, easy to install item that has very few parts. As such, it requires very little time to install.

While prior art sliding doors serve their specific purposes, no inventor has yet come up with a sliding door assembly that is pre-fabricated, easy to install has fewer functioning/moving parts, is incorporated into the structure of the house or other building, may be directly flush with the wallboard and does not require a door jamb.

### SUMMARY OF THE INVENTION

The present invention provides a pre-fabricated, easy to install sliding door that is flush with the wall and does not require a door jamb.

According to the first embodiment of the present invention, a pre-fabricated sliding door assembly is disclosed comprising: a first panel having at least one panel fastener along the top portion of the first panel for attaching the first panel to a stud; a second panel having at least one panel fastener along the top portion of the second panel for attaching the second panel to a stud; an upper track assembly fixedly attached to the first panel and the second panel; at least two fasteners for attaching the first panel to the second panel, wherein the second panel is parallel to and at least ¾ of an inch from the first panel; a door having a wheel assembly fixedly attached along the top of the door; wherein the upper track assembly receives the wheel assembly to provide a hanging, sliding door. Unlike other sliding doors that require an unsightly floor track, the present invention may hang and function from an upper track only. The fact that no lower track is necessary further facilitates handicapped wheelchair mobility and medical care facility use, and increases aesthetics, and facilitates installation of floor treatments.

According to a another embodiment of the present invention, a pre-fabricated sliding door assembly is disclosed the door assembly comprising: a first panel having at least one panel fastener along the top portion of the first panel for attaching the first panel to a stud; a second panel having at least one panel fastener along the top portion of the second panel for attaching the second panel to a stud; an upper track assembly fixedly attached to the first panel and the second panel, the upper track assembly comprising: a straight portion having a first end and a second end; a first L-shaped portion perpendicular to the straight portion and being at least one inch from the first end; and a second reversed L-shaped portion perpendicular to the straight portion, being at least one inch from the second end and parallel to the first shaped L-shaped portion; at least two fasteners for attaching the first panel to the second panel, wherein the second panel is parallel to and at least % of an inch from said first panel; a door having a wheel assembly fixedly attached along the top of the door, wherein the wheel assembly is comprised of at least one wheel and a hanging wheel attachment means, the hanging wheel attachment means comprising: a straight portion, at least one perpendicular support portion and an attaching bar portion; wherein the upper track assembly receives the wheel assembly between the first L-shaped portion and the second reversed L-shaped portion to provide a hanging, sliding door.

According to a yet another embodiment of the present invention, a pre-fabricated sliding door assembly, said door assembly comprising: a first panel having at least one panel fastener along the top portion of said first panel for attaching said first panel to a stud; a second panel having at least one panel fastener along the top portion of the second panel for attaching the second panel to a stud; an upper track assembly fixedly attached to the first panel and the second panel, the upper track assembly comprising: a straight portion having a first end and a second end, wherein the first end of the straight portion is between the first panel and the at least one panel fastener and the second end of said straight portion is between the second panel and the at least one panel fastener; a first L-shaped portion perpendicular to the straight portion and being at least one inch from the first end; and a second reversed L-shaped portion perpendicular to the straight portion, being at least one inch from the second end and parallel to the first shaped L-shaped portion; at least one upside down T shaped portion perpendicular to the first straight portion and being parallel to and between the first L-shaped portion and the second reversed L-shaped portion; at least two fasteners for attaching the first panel to the second panel, wherein the second panel is parallel to and at least % of an inch from the first panel; a door having a wheel assembly fixedly attached along the top of the door, the wheel assembly consisting of at least one wheel and a hanging wheel attachment means, wherein the hanging wheel attachment means consists of a straight portion, at least one perpendicular support portion and an attaching bar portion; at least one bumper along one side and interposed between the first panel and the second panel; wherein the upper track assembly receives the wheel assembly between the first L-shaped portion and the second reversed L-shaped portion to provide a hanging, sliding door.

This summary is not to be taken in a limiting sense, but is made merely for the purpose of illustrating the general principles of the invention, since the scope of the invention is best defined by the appended claims.

### BRIEF DESCRIPTION OF THE DRAWINGS

FIG. 1 depicts a front view of a door assembly according to the present invention;

FIG. 2 depicts a side view of a door assembly according to the present invention;

FIG. 3 depicts a side view of a door of the door assembly according to the present invention;

FIG. 4 depicts a side view of a door assembly according to the present invention;

FIG. 5 depicts a side view of a door assembly according to the present invention; and

FIG. 6 depicts a side view of a door according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

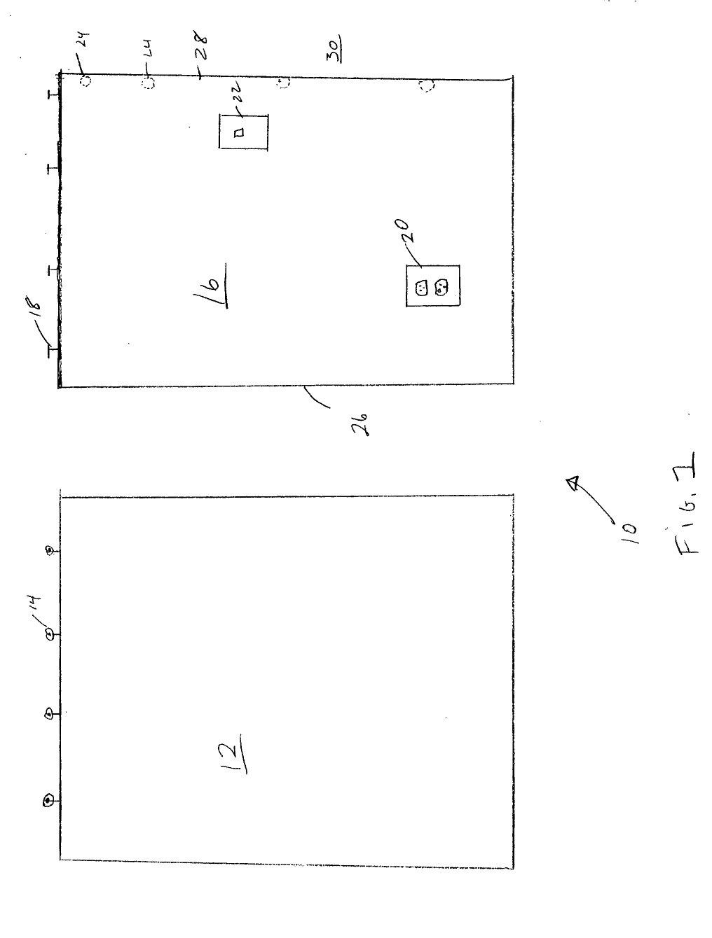

FIG. 1 depicts a front view of the door assembly 10. As shown, there is a door 12 which has at least one wheel assembly 14 fixedly attached to the top of the door. The front view shows the second panel 16. The first panel is behind the second panel 16 and not viewable from the front view. The first panel and the second panel may be made of any material suitable for walls including without limitation sheetrock, plywood, wood, plaster, fiberglass, and metal alloys.

As shown, there is at least one panel fastener 18 along the top portion of the second panel 16. The fastener would be attached to the stud or supporting member of the house. The fastener as shown is a T shaped metal device that would be screwed or hammered into place. This allows for the second panel to act as a wall and the outside portion of a sliding door. The second panel 16 will appear as any wall would appear and should be flush with the surrounding wall or sheetrock. The panel fasteners 18 would not be visible as they would be hidden behind another piece of sheetrock or portion of the wall. There may be additional fasteners for attaching the panel to the structure of the house or building. There may also be prefabricated openings for the receipt of electrical components. As shown, there may be opening sufficient in size to house a standard two plug electrical outlet 20. There may also be an opening sufficient in size to house light switch 22. There may also be at least one bumper 24 inside the first panel and second panel 16. The first panel would be attached in the same manner.

Each panel has a first side 26 and a second side 28. As shown, the first side 26 receives the door 12 and the second side 28 is flush with an adjacent portion of the wall 30. The bumpers 24 would be on the side of the panels that do not receive the door 12. As shown this would be the second side 28. It should be understood that the terms first side 26 and second side 28 are interchangeable. Each panel may have a first side and a second side, but depending on the view, the first side may be on the left or the right. Further, the first side of the first panel may be parallel to the second side of the second panel, as they are interchangeable. It is only required that one side be flush with the adjacent portion of the wall 30 and one side be open to receive the door 12. There would also be at least two fasteners for attaching the first panel 42 to the second panel 16.

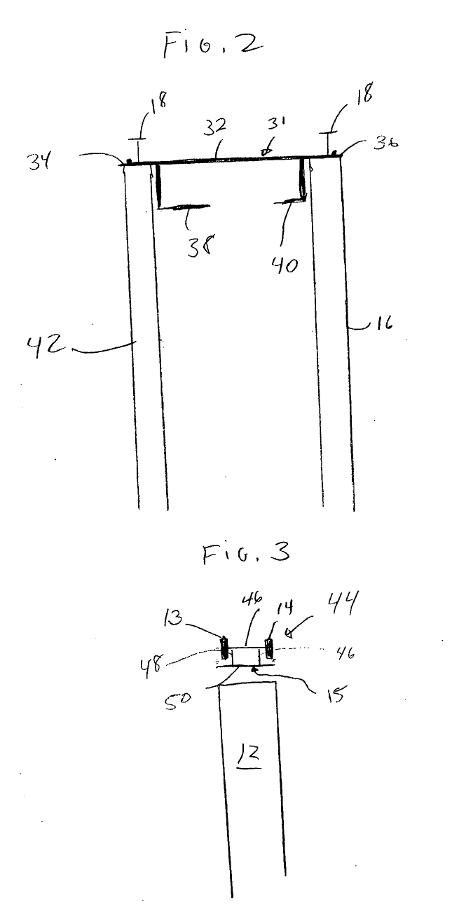

FIG. 2 depicts a side view of a top portion of the present invention including the first panel 42, second panel 16, panel fasteners 18 and upper track assembly 31. As shown, the upper track assembly may be comprised of a straight portion 32 having a first end 34 and a second end 36, a first L-shaped portion 38 perpendicular to the straight portion 32 and being at least one inch from the first end 34 and a second reversed L-shaped portion 40 perpendicular to the straight portion 32, being at least one inch from the second end 36 and parallel to the first shaped L-shaped portion 38. The first end 34 is attached to the first panel 42. The second end 36 is attached to the second panel 16. They may be attached by any means known within the arts including screws, glues, etc. The first end 34 of the straight portion may be between the top of the first panel 42 and the panel fastener 18. The second end 36 of the straight portion may be between the second panel 16 and a panel fastener 18.

FIG. 3 depicts an exploded side view of the door 12 and a wheel assembly 44 including wheels 14 and hanging wheel attachment means 15. The hanging wheel attachment means 15 consists of a straight portion 46, at least one perpendicular support (as shown there is a first support portion 46 and a second support portion 48). There is also an attaching bar portion 50. The attaching bar portion 50 is used to attach the hanging wheel attachment means 15 to the door 12. The first wheel 13 rolls along first shaped L-shaped portion 38 and the second wheel 14 rolls along the second reversed L-shaped portion 40. In this manner, there is no requirement for a door jamb and the sliding door assembly is easy to install and attractive in that it appears to be incorporated into the wall. Also, the wheels (e.g. 13,14) are hidden behind the walls and are not visible to the occupant of the room, regardless of whether the door is open or closed.

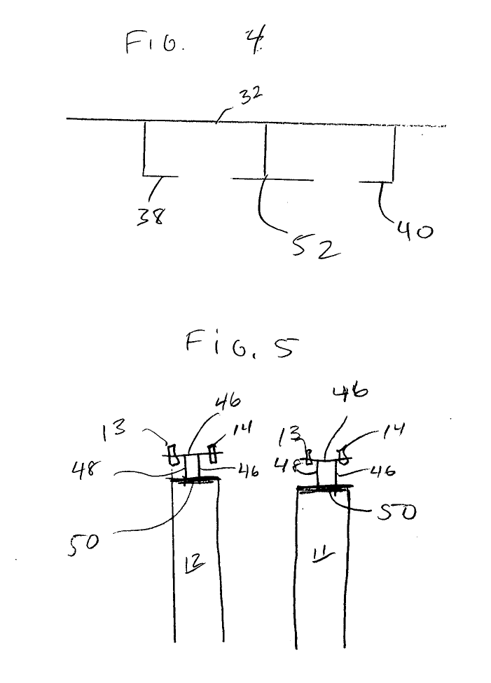

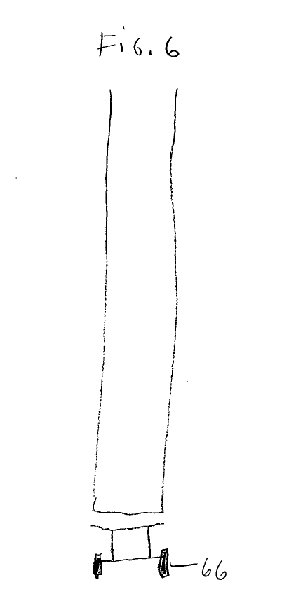

As shown in FIGS. 4-5, the present invention may also provide for more than one sliding door. For each additional sliding door, there would be an additional upside down T shaped portion 52 perpendicular to the first straight portion 32 and being parallel to and between the first L-shaped portion 38 and the second reversed L-shaped portion 40. As shown, two doors (e.g. 11, 12) may be hung in this manner. It should be understood that any number of doors or screens may be hung in this manner.

As shown in FIG. 6, for certain apparatus and high security uses, there may be a lower track 64 this may be similar to the upper track, having wheels 66 that slide along a lower track. As with any door, there may also be a standard lock on the door, that extends downward or into the side of the door.

It should be understood, of course, that the foregoing relates to preferred embodiments of the invention and that modifications may be made without departing from the spirit and scope of the invention as set forth in the following claims.

I claim:

1. A pre-fabricated sliding door assembly, said door assembly comprising:
a first panel having at least one panel fastener along the top portion of said first panel for attaching said first panel to a stud;
a second panel having at least one panel fastener along the top portion of said second panel for attaching said second panel to a stud;
an upper track assembly fixedly attached to said first panel and said second panel;
at least two fasteners for attaching said first panel to said second panel, wherein said second panel is parallel to and at least % of an inch from said first panel;
a door having a wheel assembly fixedly attached along the top of said door;
wherein said upper track assembly receives said wheel assembly to provide a hanging, sliding door.

2. The door assembly as in claim 1, wherein said upper track assembly is comprising:
a straight portion having a first end and a second end;
a first L-shaped portion perpendicular to said straight portion and being at least one inch from said first end; and
a second reversed L-shaped portion perpendicular to said straight portion, being at least one inch from said second end and parallel to said first shaped L-shaped portion.

3. The door assembly as in claim 2, wherein said upper track assembly further comprises:
at least one upside down T shaped portion perpendicular to said first straight portion and being parallel to and between said first L-shaped portion and said second reversed L-shaped portion.

4. The door assembly as in claim 1, wherein said upper track is further comprised of at least one locking detent.

5. The door assembly as in claim 2, wherein said first end of said straight portion is between said first panel and said at least one panel fastener.

6. The door assembly as in claim 2, wherein said second end of said straight portion is between said second panel and said at least one panel fastener.

7. The door assembly as in claim 1, wherein said first panel and said second panel each have a first side and a second side and said first side receives said door and said second side is flush with a portion of the wall.

8. The door assembly as in claim 1, wherein said first panel is selected from the group consisting of sheetrock, plywood, wood, plaster, fiberglass, glass and metal alloys.

9. The door assembly as in claim 1, wherein said second panel is selected from the group consisting of sheetrock, plywood, wood, plaster, fiberglass, and metal alloys.

10. The door assembly as in claim 1, wherein said wheel assembly is comprised of at least one wheel and a hanging wheel attachment means.

11. The door assembly as in claim 10, said hanging wheel attachment means consists of a straight portion, at least one perpendicular support portion and an attaching bar portion.

12. The door assembly as in claim 1, further comprising a first end of a bottom track fixedly attached to said first panel and a second end of a bottom track fixedly attached to said second panel, said first bottom track being substantially parallel to said second bottom track to provide a bottom track.

13. The door assembly as in claim 4, further comprising at least two wheels attached to the bottom of said door, wherein said at least two wheels slide along said bottom track.

14. The door assembly as in claim 1, further comprising an opening for the receipt of an electrical component.

15. The door assembly as in claim 14, wherein said opening is sufficient in size to house a light switch.

16. The door assembly as in claim 14, wherein said opening is sufficient in size to house a standard two plug electrical outlet.

17. The door assembly as in claim 1, further comprising at least one bumper along one side and interposed between said first panel and said second panel.

18. A pre-fabricated sliding door assembly, said door assembly comprising:
a first panel having at least one panel fastener along the top portion of said first panel for attaching said first panel to a stud;
a second panel having at least one panel fastener along the top portion of said second panel for attaching said second panel to a stud;
an upper track assembly fixedly attached to said first panel and said second panel, said upper track assembly comprising:
a straight portion having a first end and a second end;
a first L-shaped portion perpendicular to said straight portion and being at least one inch from said first end; and
a second reversed L-shaped portion perpendicular to said straight portion, being at least one inch from said second end and parallel to said first shaped L-shaped portion;
at least two fasteners for attaching said first panel to said second panel, wherein said second panel is parallel to and at least ¾ of an inch from said first panel;
a door having a wheel assembly fixedly attached along the top of said door, wherein the wheel assembly is comprised of at least one wheel and a hanging wheel attachment means, said hanging wheel attachment means comprising: a straight portion, at least one perpendicular support portion and an attaching bar portion;
wherein said upper track assembly receives said wheel assembly between said first L-shaped portion and said second reversed L-shaped portion to provide a hanging, sliding door.

19. The door assembly as in claim 18, wherein said upper track assembly further comprises:
at least one upside down T shaped portion perpendicular to said first straight portion and being parallel to and between said first L-shaped portion and said second reversed L-shaped portion.

20. The door assembly as in claim 18, wherein said upper track is further comprised of at least one locking detent.

21. The door assembly as in claim 18, wherein said first end of said straight portion is between said first panel and said at least one panel fastener.

22. The door assembly as in claim 18, wherein said second end of said straight portion is between said second panel and said at least one panel fastener.

23. The door assembly as in claim 18, wherein said first panel is selected from the group consisting of sheetrock, plywood, wood, plaster, fiberglass, and metal alloys.

24. The door assembly as in claim 18, wherein said second panel is selected from the group consisting of sheetrock, plywood, wood, plaster, fiberglass, and metal alloys.

25. The door assembly as in claim 18, further comprising a first end of a bottom track fixedly attached to said first panel and a second end of a bottom track fixedly attached to said second panel, said first bottom track being substantially parallel to said second bottom track to provide a bottom track.

26. The door assembly as in claim 18, further comprising at least two wheels attached to the bottom of said door, wherein said at least two wheels slide along said bottom track.

27. The door assembly as in claim 18, further comprising an opening for the receipt of an electrical component.

28. The door assembly as in claim 18, wherein said opening is sufficient in size to house a light switch.

29. The door assembly as in claim 18, wherein said opening is sufficient in size to house a standard two plug electrical outlet.

30. The door assembly as in claim 18, further comprising at least one bumper along one side and interposed between said first panel and said second panel.

31. A pre-fabricated sliding door assembly, said door assembly comprising:
a first panel having at least one panel fastener along the top portion of said first panel for attaching said first panel to a stud;
a second panel having at least one panel fastener along the top portion of said second panel for attaching said second panel to a stud;
an upper track assembly fixedly attached to said first panel and said second panel, said upper track assembly comprising:
a straight portion having a first end and a second end, wherein said first end of said straight portion is between said first panel and said at least one panel fastener and said second end of said straight portion is between said second panel and said at least one panel fastener;
a first L-shaped portion perpendicular to said straight portion and being at least one inch from said first end;
a second reversed L-shaped portion perpendicular to said straight portion, being at least one inch from said second end and parallel to said first shaped L-shaped portion;
at least one upside down T shaped portion perpendicular to said first straight portion and being parallel to and between said first L-shaped portion and said second reversed L-shaped portion;
at least two fasteners for attaching said first panel to said second panel, wherein said second panel is parallel to and at least ¾ of an inch from said first panel;
a door having a wheel assembly fixedly attached along the top of said door, said wheel assembly consisting of at least one wheel and a hanging wheel attachment means, wherein said hanging wheel attachment means consists of a straight portion, at least one perpendicular support portion and an attaching bar portion;
at least one bumper along one side and interposed between said first panel and said second panel;
wherein said upper track assembly receives said wheel assembly between said first L-shaped portion and said second reversed L-shaped portion to provide a hanging, sliding door.

32. The door assembly as in claim 31, wherein said upper track is further comprised of at least one locking detent.

33. The door assembly as in claim 31, wherein said first panel is selected from the group consisting of sheetrock, plywood, wood, plaster, fiberglass, and metal alloys.

34. The door assembly as in claim 31, wherein said second panel is selected from the group consisting of sheetrock, plywood, wood, plaster, fiberglass, and metal alloys.

35. The door assembly as in claim 31, further comprising a first end of a bottom track fixedly attached to said first panel and a second end of a bottom track fixedly attached to said second panel, said first bottom track being substantially parallel to said second bottom track to provide a bottom track.

36. The door assembly as in claim 31, further comprising at least two wheels attached to the bottom of said door, wherein said at least two wheels slide along said bottom track.

37. The door assembly as in claim 31, further comprising an opening for the receipt of an electrical component.

38. The door assembly as in claim 31, wherein said opening is sufficient in size to house a light switch.

39. The door assembly as in claim 31, wherein said opening is sufficient in size to house a standard two plug electrical outlet.
